(19) United States
(12) Patent Application Publication
(10) Pub. No.: US 2026/0219816 A1
(43) Pub. Date: Jul. 30, 2026

(54) PRINTER AND NON-TRANSITORY COMPUTER READABLE STORAGE MEDIUM

(71) Applicant: BROTHER KOGYO KABUSHIKI KAISHA, Nagoya (JP)

(72) Inventor: Kazuhide SAWADA, Nagoya (JP)

(73) Assignee: BROTHER KOGYO KABUSHIKI KAISHA, Nagoya (JP)

(21) Appl. No.: 19/450,482

(22) Filed: Jan. 15, 2026

(30) Foreign Application Priority Data
Jan. 29, 2025 (JP) 2025-013145

(51) Int. Cl. G06F 3/12

(52) U.S. Cl. CPC G06F 3/1232; G06F 3/1205; G06F 3/1228; G06F 3/1255; G06F 3/1287

(57) ABSTRACT

A printer includes a print engine, and a communication interface. The printer is configured to receive a print job from an IPP client via the communication interface, according to internet printing protocol (IPP), and cause the print engine to perform printing based on the received print job. The printer is configured to respond with capability information in response to receiving a specific command from the IPP client via the communication interface, the specific command being specified by IPP and requesting the capability information, the capability information indicating capabilities of the printer. The specific command includes a parameter for designating a requested capability, the parameter for designating a requested capability including a plurality of types, the plurality of types including a specified parameter that is the parameter specified in the IPP and a unique parameter that is the parameter not specified in the IPP.

### REFERENCE TO RELATED APPLICATIONS

This application claims priority from Japanese Patent Application No. 2025-013145 filed on January 29, 2025. The entire content of the priority application is incorporated herein by reference.

### BACKGROUND ART

In recent years, a technology has been put into practical use in which a printer is controlled by a general-purpose printing program included in an operating system (OS) without using a printer driver provided by a printer vendor. With this technology, when the OS detects a printer, the OS associates the printer with a general-purpose printing program, and then, when a print instruction for that printer is received, the general-purpose printing program transmits print data to the printer in a manner specified in IPP, allowing the printer to print with the manner specified in IPP. For example, Patent Literature 1 discloses a printing technique using a general-purpose printing program.

Printing using a general-purpose printing program included in the OS does not necessarily make full use of functions of a printer. For example, even if the printer is capable of operating according to own specifications that are not specified in the IPP, when printing using a general-purpose printing program, the functions of the own specifications that are not specified in the IPP may not be used. That is, the capabilities originally held by the printer may not be fully utilized.

### SUMMARY

A printer includes a print engine and a communication interface. The printer is configured to receive a print job from an IPP client via the communication interface, according to internet printing protocol (IPP), and cause the print engine to perform printing based on the received print job. The printer is configured to respond with capability information in response to receiving a specific command from the IPP client via the communication interface, the specific command being specified by IPP and requesting the capability information, the capability information indicating capabilities of the printer. The specific command includes a parameter for designating a requested capability, the parameter for designating a requested capability including a plurality of types, the plurality of types including a specified parameter that is the parameter specified in the IPP and a unique parameter that is the parameter not specified in the IPP. The printer is further configured to in a case where the unique parameter is not included in the received specific command, respond with the capability information that includes, among the capabilities of the printer, a capability specified in the IPP and that does not include a capability not specified in the IPP, and in a case where the unique parameter is included in the received specific command, respond with the capability information that includes, among the capabilities of the printer, a unique capability of the printer that is designated by the unique parameter and is not specified in the IPP.

### BRIEF DESCRIPTION OF DRAWINGS

FIG. 1 is a block diagram showing an outline of an electrical configuration of an MFP.

FIG. 2A is a sequence diagram showing an example of a printing procedure.

FIG. 2B is a sequence diagram showing an example of the printing procedure.

FIG. 3 is a flowchart showing an example of a procedure for a parameter determination process.

FIG. 4 is a flowchart showing an example of a procedure for a response capability determination process.

FIG. 5 is a flowchart showing an example of a procedure for an integration process.

FIG. 6 is a diagram illustrating an example of a print setting screen.

FIG. 7 is a diagram illustrating an example of the print setting screen on which options for a color mode are being displayed.

FIG. 8 is a flowchart showing an example of a procedure for the response capability determination process.

FIG. 9 is a diagram illustrating an example of the relationship between a capability value of the MFP and options for print settings.

### DESCRIPTION

Hereinafter, a first embodiment embodying a printer will be described in detail with reference to the accompanying drawings. The present specification discloses a multi function device (hereinafter, referred to as an "MFP") having a printing function and a communication function.

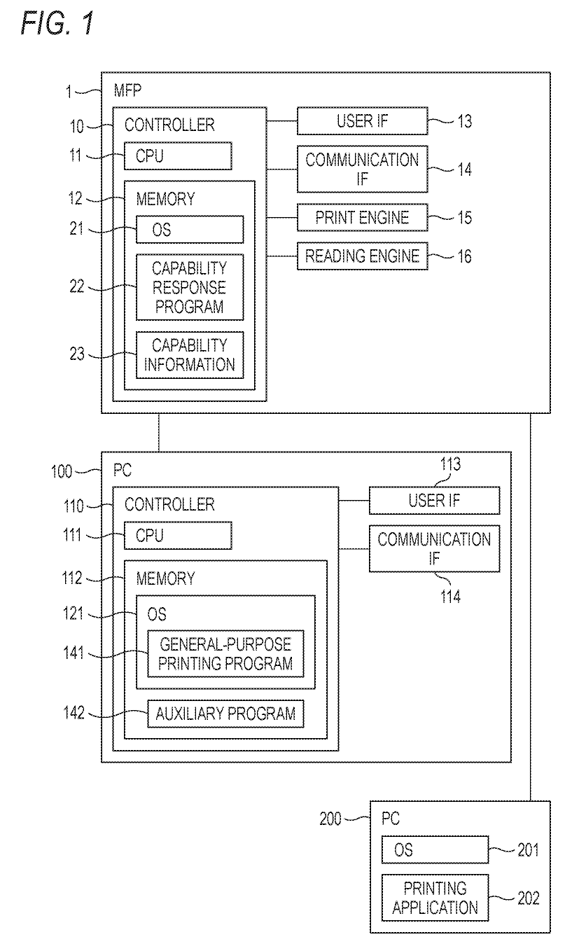

As illustrated in FIG. 1, an MFP 1 according to the present embodiment includes, for example, a controller 10 including a CPU 11 and a memory 12. The MFP 1 includes a user interface (hereinafter, referred to as a "user IF") 13, a communication interface (hereinafter, referred to as a "communication IF") 14, a print engine 15, and a reading engine 16 that are electrically connected to the controller 10. The MFP 1 is an example of a printer. The controller 10 in FIG. 1 is a collective term for hardware and software used to control the MFP 1, and does not necessarily represent a single piece of hardware actually present in the MFP 1.

The CPU 11 of the MFP 1 is configured to execute various types of processes, in accordance with a program read from the memory 12 and based on a user operation. The memory 12 of the MFP 1 is configured to store various types of programs and various types of data including an operating system (hereinafter, referred to as an "OS") 21, a capability response program 22, and capability information 23. The memory 12 is used as a work area in a case where various types of processes are executed. A buffer provided in the CPU 11 is also an example of the memory 12. The program and data will be described later in detail.

An example of the memory 12 is not limited to a ROM, a RAM, an HDD, and the like incorporated into the MFP 1, and may be a storage medium configured to be read and written by the CPU 11. For example, an external memory such as a USB memory or an HDD connected to the MFP 1, or a memory or an HDD provided in a device connected to the MFP 1 via the communication IF 14 is also an example of the memory 12.

The computer-readable storage medium is a non-transitory medium. The non-transitory medium also includes a recording medium such as a CD-ROM or a DVD-ROM, in addition to the above-described examples. The non-transitory medium is also a tangible medium. On the other hand, an electric signal conveying a program downloaded from a server or the like on the internet is a computer-readable signal medium, which is a kind of computer-readable medium, but is not included in the non-transitory computer-readable storage medium.

The user IF 13 includes, for example, a touch panel. The touch panel includes hardware configured to display a screen for notifying a user of information, and hardware configured to receive an operation from the user. The user IF 13 may include a combination of a display and a hardware button or the like.

The communication IF 14 includes hardware for communicating with an external device. The communication IF 14 has functions compatible with communication standards such as Wi-Fi (registered trademark), Ethernet (registered trademark), and USB. The MFP 1 according to the present embodiment can communicate with various IPP clients in accordance with the internet printing protocol (IPP) via the communication IF 14. The MFP 1 may include a plurality of communication IFs 14 corresponding to a plurality of communication standards. The MFP 1 may be capable of communicating in accordance with a standard other than IPP.

The print engine 15 includes a configuration for printing an image on a print medium such as a sheet. An image formation method of the print engine 15 is, for example, an electrophotograph method or an ink-jet method. The MFP 1 according to the present embodiment may include the print engine 15 that is capable of executing color printing using a multicolor colorant, or may include the print engine 15 that performs only monochrome printing using a monochrome colorant.

The reading engine 16 includes a configuration for scanning a document placed on a flatbed or a document placed on a document feeder and conveyed to a reading position, and generating scan data as a scan result. The MFP 1 of the present embodiment may include a reading engine 16 capable of executing color reading for reading a document as a color image, or may include a reading engine 16 capable of executing only monochrome reading, which reads the document as a monochrome image.

The MFP 1 of the present embodiment can handle a print job from an external device that does not use a unique printer driver, that is, so-called driverless printing. Various external devices can transmit a print job to the MFP 1 through communication according to the IPP by using, for example, an IPP Class Driver or a client program compatible with AirPrint, Mopria, or IPP Everywhere. The MFP 1 can communicate with various external devices by communication according to the IPP, and can execute printing based on print jobs received from various external devices.

Specifically, as shown in FIG. 1, the MFP 1 of the present embodiment can be connected to a personal computer (hereinafter referred to as "PC") 100 and a PC 200. The PC 100 and the PC 200 are devices capable of transmitting a print job to the MFP 1 in accordance with the IPP, and are both examples of an IPP client. The MFP 1 can cause the print engine 15 to perform printing based on the received print job both when the print job is received from the PC 100 and when the print job is received from the PC 200.

As illustrated in FIG. 1, the PC 100 includes a controller 110 including a CPU 111 and a memory 112, a user IF 113, and a communication IF 114. The PC 100 is an example of an information processing device, and the CPU 111 is an example of a computer.

The memory 112 of the PC 100 has Windows (registered trademark) installed as an OS 121. The OS 121 includes a general-purpose printing program 141. It may be said that the OS 121 has a general-purpose print program 141 that is standard for the OS. It may be said that the OS 121 is equipped with the general-purpose printing program 141. The PC 100 is an example of a first type of IPP client. The OS 121 is an example of a specific operating system.

The general-purpose printing program 141 is an OS-standard program prepared by a vendor of the OS 121 and provided as a part of the OS 121. The general-purpose printing program 141 is a printing program that is installed in the OS 121 in advance, and is, for example, a printing program that is packaged in the OS 121 and installed in the PC 100 together with the OS 121. Examples of the general-purpose printing program 141 include an IPP Class Driver provided by Microsoft (registered trademark) Corporation. The general-purpose printing program 141 is an example of an IPP client program. The general-purpose printing program 141 is not configured to use a printer driver specific to the printer.

The PC 100 further includes an auxiliary program 142 which is a program compatible with the MFP 1. The auxiliary program 142 is a program or a group of programs that cooperate with the general-purpose printing program 141 and execute processes based on an instruction from the OS 121 in association with the process of the general-purpose printing program 141. The auxiliary program 142 is, for example, an application program provided by a vendor of the MFP 1, and is a program that supports control of the MFP 1. The auxiliary program 142 is an example of a support program and an example of a print support program.

For example, when an instruction to add a new printer to the PC 100 is received, the OS 121 of the PC 100 can download an appropriate auxiliary program depending on a type or a model of the added printer from a server of a vendor of the added printer, or from a storage designated by the OS 121, or the like, and incorporate the downloaded auxiliary program into the PC 100. For example, when the MFP 1 is added to the PC 100, the OS 121 incorporates the auxiliary program 142 into the PC 100 and stores identification information of the incorporated auxiliary program 142 in the memory 112 in association with information indicating the MFP 1.

The general-purpose printing program 141 activates the auxiliary program 142 compatible with the MFP 1 when the MFP 1 is selected as a device for executing printing, when an instruction for detailed print setting is received in a state where the MFP 1 is selected, when an instruction for causing the MFP 1 to execute printing is received, or the like. Further, the general-purpose printing program 141 can acquire various types of information from the MFP 1 via the OS 121 by communication according to the IPP. For example, in response to a request from the auxiliary program 142, the general-purpose printing program 141 can transmit a command to the MFP 1 requesting capability information, and pass the capability information acquired from the MFP 1 to the auxiliary program 142.

The capability information includes information on setting values that can be set as print settings when printing is executed by the MFP 1. The capability information may include, for example, information indicating whether a color printing function is available, information on the number of sheet feed trays and the sheet contained in the sheet feed trays, and information indicating selectable print quality. The auxiliary program 142 can use the capability information acquired from the MFP 1 in a process for printing.

On the other hand, the PC 200 includes an OS 201 other than Windows (registered trademark). The OS 201 is, for example, macOS (registered trademark), Linux (registered trademark), iOS (registered trademark), or Android (registered trademark). The OS 201 of the PC 200 does not include a program equivalent to the general-purpose printing program 141. Further, the PC 200 does not have an auxiliary program that executes processes in cooperation with the general-purpose printing program. The PC 200 is an example of a second type of IPP client.

The PC 200 includes an application program for printing (hereinafter, referred to as a "printing application") 202 that is different from the general-purpose printing program 141 and the auxiliary program 142 of the PC 100. The printing application 202 can transmit a print job to the MFP 1 by communication according to the IPP. The printing application 202 is, for example, AirPrint, Mopria, or IPP Everywhere.

The printing application 202 of the PC 200 can acquire various types of information from the MFP 1 via the OS 201 of the PC 200 by communication according to the IPP. For example, the printing application 202 can transmit a command requesting capability information to the MFP 1, acquire the capability information from the MFP 1, and use the capability information for processes for printing. The printing application 202 is a program compatible with various printing devices, and is not a program prepared specifically for the MFP 1.

A command for requesting the capability of the MFP 1 through the communication according to the IPP is, for example, a "get-printer-attributes" command, which is a capability request command specified by the IPP. The "get-printer-attributes" command is an example of a specific command. The capability request command can include various parameters. Each parameter included in the capability request command is, for example, information designating the content to be returned as capability information.

The PC 100 or the PC 200 transmits a capability request command and a parameter thereof to the MFP 1 according to the IPP as necessary. The MFP 1 generates the capability information including a capability value corresponding to each parameter included in the command, and responds to the transmission source of the capability request command. The MFP 1 can respond with the capability information by communication according to the IPP whether the command is requested from the PC 100 or from the PC 200.

In the IPP, a plurality of types of parameters that can be included in the capability request command are specified as standard parameters. Hereinafter, the standard parameters specified in the IPP are referred to as "specified parameters". Further, in the IPP, a value that can be responded to for each specified parameter is specified in advance. Hereinafter, a capability value specified in the IPP as a capability to respond corresponding to each specified parameter is referred to as a "specified capability value".

For example, the specified parameter requesting the capability information related to the function of the color mode included in the MFP 1 is "print-color-mode-supported", and the specified capability values for this parameter are three types of values indicating information of "auto", "color", and "monochrome". This parameter is used to request the MFP 1 to respond with capability information including a capability value indicating whether the MFP 1 has a color printing function. By transmitting the capability request command including the specified parameter and receiving the capability information as a response, the PC 100 or PC 200 can determine the options regarding the color mode setting that can be accepted as the print settings for the printing in the MFP 1.

For example, when a capability request command including the above parameters is received, the MFP 1 responds with a capability value including information indicating "color" if color printing can be executed, information indicating "monochrome" if monochrome printing can be executed, and information indicating "auto" if the MFP 1 has the function of determining whether the image to be printed is in color and printing the image accordingly. For example, in a case where the MFP 1 is a device capable of executing both color printing and monochrome printing and has the function of determining whether the image to be printed is in color, the MFP 1 responds with capability information including these three types of capability values. When the capability information is received, the PC 100 or the PC 200 can accept a selection from three types of options, auto, color, and monochrome, as the color mode of the print settings. An MFP capable of executing monochrome printing are often also capable of grayscale printing. Therefore, an IPP client that receives a capability value that includes the information indicating "monochrome" may display not only a monochrome option but also a grayscale option.

Further, for example, the MFP 1 that cannot execute color printing responds with capability information including only one type of capability value indicating "monochrome" as the specified capability value corresponding to the "print-color-mode-supported" parameter. When the capability information is received, the PC 100 or the PC 200 can accept monochrome and grayscale as the color mode of the print setting. The PC 100 or the PC 200 may be able to accept only monochrome as the color mode of the print setting.

The MFP 1 may have a capability not included in the specified capability value as a capability related to the color mode. When functions are expanded by update of firmware or the like, it may become possible for the device to acquire capabilities that are not included in the specified capability value. For example, the MFP 1 may have the capability to perform color printing adjusted to natural tones, color printing adjusted to vivid tones, and color printing with colors set to be numerically linear without adjustment.

However, since the specified capability values for the specified parameters related to the color mode do not include capability values indicating these various types of color printing, the MFP 1 cannot respond with these capability values as specified capability values in response to a capability request command. Therefore, the vendor of the MFP 1 transmits a capability request command including a parameter different from the specified parameter, so that the MFP 1 can respond with a capability not included in the specified capability value as a capability value. Hereinafter, parameters that are not specified parameters of the IPP are referred to as "unique parameters". A capability value that is not the specified capability value is referred to as a "unique capability value". The MFP 1 of the present embodiment can respond a capability request command including a unique parameter with a capability value including a unique capability value.

Further, the above-described IPP Class Driver and client programs compatible with AirPrint, Mopria, IPP Everywhere, and the like are general-purpose printing programs that are compatible with many types of printers available on the market, and are not programs unique to printers of a specific vendor. Therefore, various general-purpose printing programs such as the general-purpose printing program 141 of the PC 100 do not correspond to the unique parameter or the unique capability value. Therefore, a vendor of a printer having a unique capability such as MFP 1 has developed, for example, the auxiliary program 142 described above as a program corresponding to the unique parameter and the unique capability value.

Next, the operation of the MFP 1 will be described. The following processes basically represent processes of the CPU according to commands written in programs. That is, the processes such as "judgment", "extraction", "selection", "calculation", "determination", "specification", "acquisition", "reception", and "control" to be described below represent the processes of the CPU. The processes by the CPU also include hardware control using API of the OS. In the present specification, the description of the OS is omitted, and an operation of each program is described. That is, in the following description, the description that "a program B controls hardware C" may refer to "the program B controls the hardware C, using the API of the OS". In addition, the processes of the CPU according to the commands written in the programs may be described in omitted words. For example, the processes of the CPU may be described as "the CPU performs". In addition, the processes of the CPU according to the commands written in the programs may be described in words in which the CPU is omitted, such as "the program A performs".

In addition, in the present specification, "notification", "alert", "notifying", "reply", "response", "answer", and the like are not limited to a meaning of transmission of information to a person, and are also used as words meaning communication or exchange of information between devices or between components in a device. The configuration in the device includes software.

The term "acquisition" is used as a concept indicating that a request is not essential. That is, a process of receiving data without a request from the CPU is also included in a concept indicating that "the CPU acquires data". In addition, the term "data" in the present specification is represented by a computer-readable bit string. Furthermore, data having substantially the same meaning and different formats are treated as the same data. The same applies to "information" in the present specification. In addition, the term "request" or "instruct" is a concept indicating that information indicating that a request is being made or information indicating that an instruction is being given is output to a partner. In addition, the information indicating that a request is being made or the information indicating that an instruction is being given is simply referred to as a "request" or "instruction".

According to the CPU, a process of determining whether information A indicates that it is a matter B may be conceptually described as "determining whether it is the matter B, based on the information A". According to the CPU, a process of determining whether the information A indicates that it is the matter B or a matter C may be conceptually described as "determining whether it is the matter B or the matter C, based on the information A".

In the present specification, a setting item may be simply referred to as "setting". A setting value may be simply referred to as "setting". The setting value may be described as a "parameter". Furthermore, storing the setting value in a memory or the like may be simply referred to as "setting". An operation for setting or input for setting may be simply referred to as "setting".

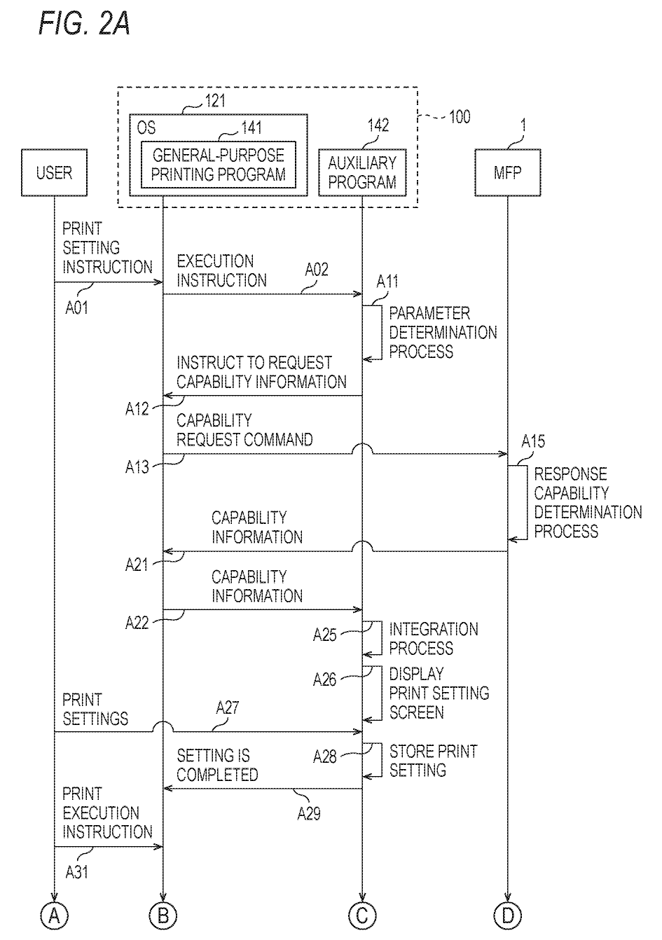

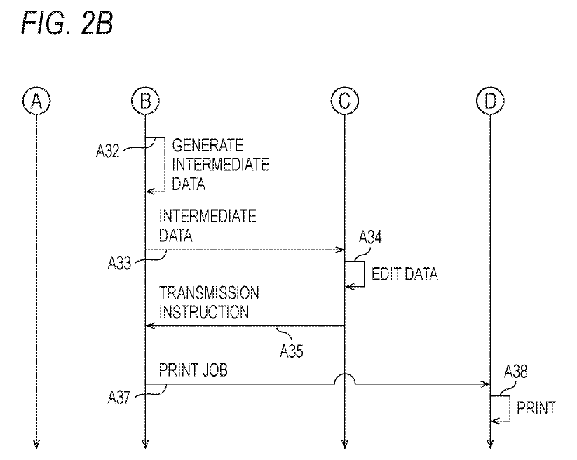

A procedure for causing the MFP 1 to execute printing using the PC 100 will be described with reference to the sequence diagram of FIGS. 2A and 2B. Various programs incorporated in the PC 100, for example, application programs for creating or editing a document or an image activate the general-purpose printing program 141 when the use of the printing function is selected. When a user who uses the PC 100 wants the MFP 1 to execute printing, the user selects the MFP 1 as a device to execute printing.

The general-purpose printing program 141 activates the auxiliary program 142 corresponding to the MFP 1 in a case where the MFP 1 is selected at the time of activation or in a case where an instruction to change the printing device to the MFP 1 is received. Further, for example, in a case where an instruction to start detailed print setting is received (A01), the general-purpose printing program 141 passes an execution instruction including an instruction to receive the print setting to the auxiliary program 142 (A02).

For example, the auxiliary program 142 can acquire the capability information of the MFP 1 in a case where an activation instruction is received, in a case where provision of information is requested from the general-purpose printing program 141, or in a case where information indicating that an instruction to perform detailed print settings is received is passed over. The auxiliary program 142 instructs the general-purpose printing program 141 to transmit a capability request command to the MFP 1, and acquires a capability value from the MFP 1 via the general-purpose printing program 141, for example.

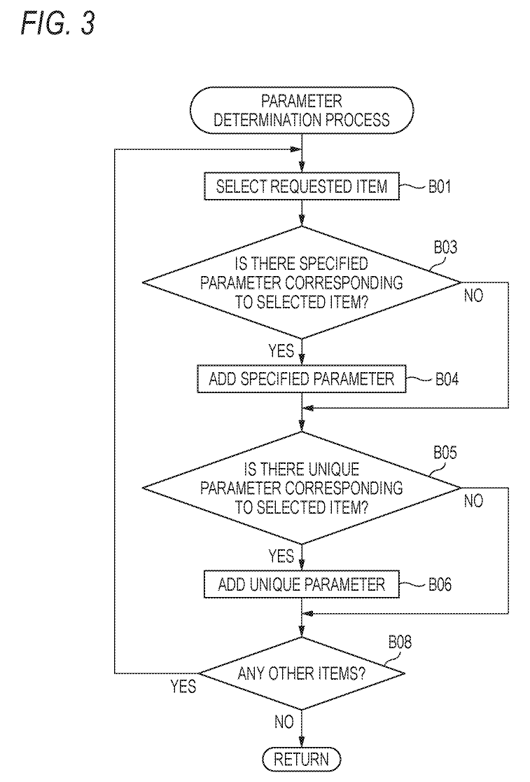

When the auxiliary program 142 receives the instruction in A02 and acquires the capability information of the MFP 1, the auxiliary program 142 executes a parameter determination process for determining a parameter to be included in the capability request command (A11). A procedure of the parameter determination process will be described with reference to a flowchart in FIG. 3. The parameter determination process is executed by the CPU 111 of the PC 100 according to the auxiliary program 142.

In the parameter determination process, the CPU 111 selects one item indicating the requested capability (B01). Since there are many types of parameters that can be included in the capability request command, the auxiliary program 142 can request only the capability required at that time. The auxiliary program 142 may not request information that is already held or information that is unlikely to be changed in a short period of time, for example, model information of the MFP 1 or information indicating a communication mode with the MFP 1, if the information has already been acquired.

CPU 111 determines whether there is a specified parameter corresponding to the item selected in B01 (B03). If it is determined that the specified parameter is present (B03: YES), the CPU 111 adds the specified parameter to the parameter included in the capability request command (B04). The auxiliary program 142 may have information on various parameters that can be included in the capability request command in advance, or may acquire the information from a server or the like provided by the general-purpose printing program 141 or the vendor of the MFP 1.

The specified parameters specified in the IPP include, for example, "document-format-supported", which requests information on a supported file format, "compression-supported", which requests information on a supported compression format, "media-ready", which requests information on a default printing sheet, "print-color-mode-supported", which requests information on a supported color mode, and "print-quality-supported", which requests information indicating a type of supported print quality. For example, if the item selected in B01 is an item indicating the color mode, the CPU 111 adds "print-color-mode-supported" in B04.

After B04 or if it is determined that there is no specified parameter, (B03: NO), the CPU 111 determines whether there is a unique parameter corresponding to the item selected in B01 (B05). The unique parameter is a parameter for requesting a unique capability value as a capability value related to each item, and is a parameter that can be handled by both the MFP 1 and the auxiliary program 142.

For example, when it is determined that the item selected in B01 is the color mode and there is a unique parameter "vendor-custom-print-color-mode-supported" corresponding to the color mode, the CPU 111 adds this parameter in B06. This unique parameter is a parameter that requests a unique capability value, which is a capability value other than the specified capability value, as the capability of the color mode. Specifically, this unique parameter is a parameter that requests a capability value indicating whether each of the capabilities of "custom_normal", "custom_vivid", and "custom_none" is accessible. By B04 and B06, both the specified parameter and the unique parameter are added as parameters requesting a capability value related to the color mode.

The unique parameters included in the auxiliary program 142 may or may not include corresponding specified parameters. Examples of the unique parameters include "vendor-custom-density-supported" and "vendor-custom-contrast-supported", which request a capability value indicating a settable range for density and contrast, "vendor-custom-toner-save-supported", which requests a capability value indicating whether a toner save mode is enabled, and "vendor-custom-print-quality-supported", which requests a capability value other than a specified capability value as print quality. Among these four types of parameters, there is a corresponding specified parameter for the unique parameter indicating the print quality, but there is no corresponding specified parameter for the other three parameters.

If it is determined that there is a unique parameter corresponding to the selected item (B06: YES), the CPU 111 adds the unique parameter to the parameters included in the capability request command (B06). If there is a specified parameter corresponding to the selected item, both the specified parameter and the unique parameter are added.

After B06, or if it is determined that there is no unique parameter (B05: NO), the CPU 111 determines whether there is another item requesting a capability value (B08). If it is determined that there is another item (B08: YES), the CPU 111 proceeds to B01, selects the next item, and adds a parameter corresponding to the selected item. If it is determined that there are no other items (B08: NO), the CPU 111 ends the parameter determination process.

By this parameter determination process, the auxiliary program 142 corresponding to the MFP 1 of the present embodiment can add a unique parameter, which requests a unique capability value indicating a capability unique to the MFP 1 and differs from the specified parameter, as a parameter to be included in the capability request command. Then, the auxiliary program 142 can instruct the general-purpose printing program 141 to transmit a capability request command including the parameter determined in the parameter determination process to the MFP 1. The capability request command including the parameter determined in the parameter determination process is an example of the specific command.

The specified parameters specified in the IPP include a parameter that collectively requests information of a plurality of items. When requesting information of a plurality of items, the CPU 111 may add a parameter for collectively requesting information of the plurality of items in B04, instead of adding a parameter for each item.

The CPU 111 may add, for example, "all" which collectively requests all of the specified capability values held by the MFP 1, and "printer-description" or "job-template" which are parameters that specify a specific group and request a plurality of specified capability values included in the specific group. "all" is a parameter having the same meaning as listing all the specified parameters. Further, "printer-description" is a parameter that collectively requests "document-format-supported", "compression-supported", "media-ready", and the like. "job-template" is a parameter that collectively requests "print-color-mode-supported", "print-quality-supported", and the like.

Parameters such as "all" that collectively request information on a plurality of items are included in the specified parameters. General-purpose printing programs such as the general-purpose printing program 141, the above-described IPP Class Driver, and general-purpose printing programs that are compatible with AirPrint, Mopria, and IPP Everywhere can transmit a capability request command that includes various specified parameters, and therefore can transmit a capability request command that includes parameters that collectively request information on a plurality of items.

The description returns to the printing procedure shown in the sequence diagram of FIGS. 2A and 2B. After completing the parameter determination process in A11, the auxiliary program 142 passes the capability request command including the determined parameter to the general-purpose printing program 141, and instructs the general-purpose printing program 141 to transmit the capability request command to MFP 1 (A12). As a result, the general-purpose printing program 141, in response to the instruction from the auxiliary program 142, transmits the capability request command and the parameters thereof to the MFP 1 according to the IPP (A13).

Upon receiving the capability request command transmitted in A13, the MFP 1 generates capability information indicating its own capability values to respond to, based on the parameters included in the capability request command. Therefore, the MFP 1 executes a response capability determination process (A15).

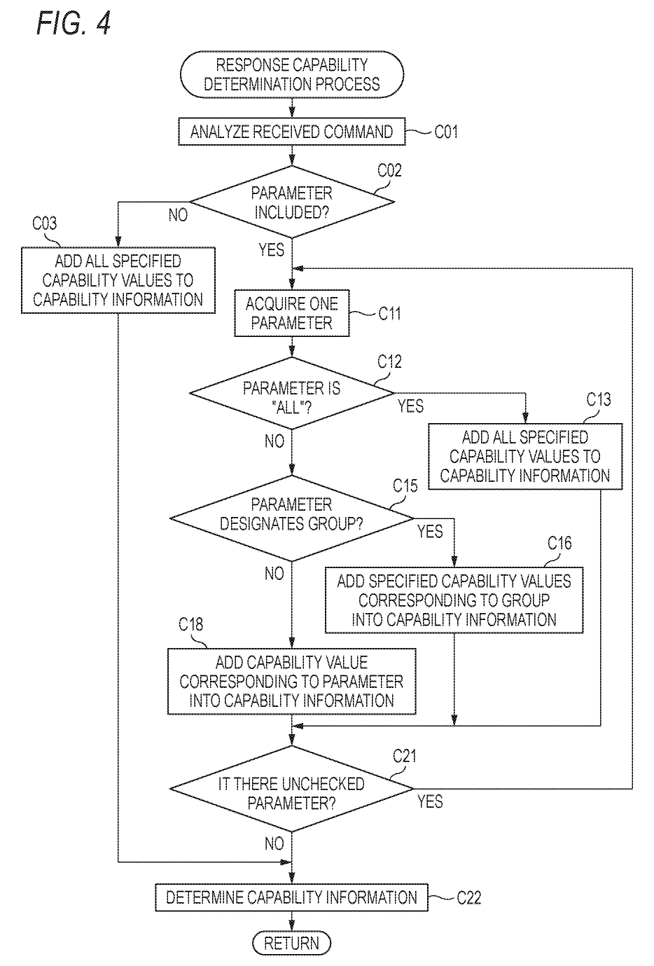

A procedure of the response capability determination process will be described with reference to a flowchart in FIG. 4. The response capability determination process is executed by the CPU 11 of the MFP 1 according to the capability response program 22 (see FIG. 1) of the MFP 1. At the start of the response capability determination process, the CPU 11 prepares capability information that does not include any information as response information.

In the response capability determination process, the CPU 11 analyzes the received capability request command (C01). Then, the CPU 11 determines whether the received capability request command includes a parameter (C02). If it is determined that the capability request command does not include a parameter (C02: NO), the CPU 11 adds all the specified capability values to the capability information, for example, based on the capability information 23 (see FIG. 1) stored in the memory 12 (C03). A capability request command that does not include a parameter has the same meaning as a command that includes only the specified parameter "all" as a parameter.

If it is determined that the capability request command includes parameters (C02: YES), the CPU 11 checks each parameter included in the command in order. The CPU 11 acquires one parameter to be checked (C11). Then, it is determined whether the acquired parameter is "all" (C12). If it is determined that the parameter is "all" (C12: YES), the CPU 11 adds all the specified capability values to the capability information (C13). Note that the CPU 11 does not add a unique capability value in response to the "all" parameter.

If it is determined that the parameter to be checked is not "all" (C12: NO), the CPU 11 determines whether the parameter is a parameter that designates a group (C15). If it is determined that the parameter is a parameter that designates a group (C15: YES), the CPU 11 adds the specified capability values corresponding to all the specified parameters included in the designated group to the responding capability information (C16). The CPU 11 does not add a unique capability value in response to the parameter that designates a group.

If it is determined that the parameter is not a parameter that designates a group (C15: NO), the CPU 11 adds a capability value corresponding to the acquired parameter to be checked to the capability information (C18). For example, if the capability request command includes a parameter that designates a print setting item, the CPU 11 adds, to the capability information, information indicating options and ranges of setting values that can be set for the print setting item.

In C18, if the parameter to be checked is a specified parameter, the CPU 11 adds a specified capability value, and if the parameter to be checked is a unique parameter, the CPU 11 adds a unique capability value. For example, if the parameter to be checked is the specified parameter "print-color-mode-supported", the CPU 11 adds a compatible capability value from the specified capability values "auto", "color", and "monochrome" to the capability information. Since the MFP 1 of the present embodiment can support all of the three types of color modes, all the specified capability values are added to the capability information.

For example, if the parameter to be checked is the unique parameter "vendor-custom-print-color-mode-supported", the CPU 11 adds a compatible capability value from the unique capability values "custom_normal", "custom_vivid", and "custom_none" to the capability information. Since the MFP 1 of the present embodiment can support all of the three types of color modes, all the unique capability values are added to the capability information.

Then, the CPU 11 determines whether there is an unchecked parameter (C21). If it is determined that there is an unchecked parameter (C21: YES), the CPU 11 proceeds to C11 and acquires the next parameter as a parameter to be checked. After C03, or if it is determined that all parameters included in the capability request command have been confirmed (C21: NO), the CPU 11 determines the capability information to which each capability value has been added as the information to respond (C22), and ends the response capability determination process.

The PC 200 does not have the general-purpose printing program 141 or the auxiliary program 142. The printing application 202 of the PC 200 is a general-purpose printing program that is not a program prepared for the MFP 1. Therefore, a general-purpose printing program such as the printing application 202 does not transmit a capability request command including a unique parameter. A general-purpose printing program such as the printing application 202 can transmit to the MFP 1 a capability request command including a specified parameter and a capability request command including a parameter such as "all" that collectively requests a plurality of specified capability values. Therefore, the MFP 1 responds to the PC 200 with the capability information that includes only the specified capability values corresponding to the specified parameter.

Further, the MFP 1 can respond with a unique capability value that is not specified in the IPP, but responds with only the specified capability value to a capability request command that includes only the specified parameter. When the MFP 1 receives a capability request command including a parameter such as "all" for collectively requesting the specified capability values, the MFP 1 responds with only the specified capability values regardless of whether the transmission source is the printing application 202, the general-purpose printing program 141 that does not cooperate with the auxiliary program 142, or the general-purpose printing program 141 that cooperates with the auxiliary program 142. For example, when the general-purpose printing program 141 of the PC 100 does not cooperate with the auxiliary program 142, the capability request command transmitted from the PC 100 does not include the unique parameter. In this case, the MFP 1 responds to the PC 100 with the capability information that includes only the specified capability values corresponding to the specified parameter.

In this way, since the MFP 1 responds only with the specified capability value to the capability request command that includes the specified parameters, the vendor of MFP 1 does not need to re-perform authentication of standards such as AirPrint, Mopria, and IPP Everywhere, even if a new unique capability is added to the MFP 1 through an update or the like.

The description returns to the printing procedure shown in the sequence diagram of FIGS. 2A and 2B. After completing the response capability determination process in A15, the MFP 1 transmits the determined capability information to the general-purpose printing program 141 of the PC 100, which is the transmission source of the capability request command, as a response to the received capability request command (A21). The MFP 1 responds with the capability information in a format specified by the IPP. By responding in the format specified by the IPP, the PC 100 can easily use the capability information including the unique capability of the MFP 1.

The general-purpose printing program 141 passes the capability information acquired from the MFP 1 to the auxiliary program 142 (A22). Accordingly, the auxiliary program 142 can acquire the capability information of the MFP 1. A12 to A22 are examples of a capability acquisition process. The general-purpose printing program 141 normally does not analyze the returned capability information, but passes it directly to the auxiliary program 142.

As described above, the auxiliary program 142 generates the capability request command including the specified parameter and the unique parameter, and transmits the capability request command to the MFP 1. When the capability request command including the specified parameter and the unique parameter is received, the MFP 1 responds with capability information including a specified capability value corresponding to the specified parameter and a unique capability value corresponding to the unique parameter. Therefore, the auxiliary program 142 can acquire not only the specified capability value of the MFP 1 but also the unique capability value of the MFP 1 that is not specified by the IPP.

Instead of causing the general-purpose printing program 141 to transmit one capability request command including both the specified parameter and the unique parameter, the auxiliary program 142 may cause the general-purpose printing program 141 to transmit a capability request command including the specified parameter and a capability request command including the unique parameter separately. In this case, the MFP 1 responds with a specified capability value in response to the capability request command including the specified parameter, and responds with a unique capability value in response to the capability request command including the unique parameter. The auxiliary program 142 can acquire the specified capability value and the unique capability value by acquiring both the two responses to the two commands. In this case, the capability request command including the specified parameter is an example of a first specific command, and the capability request command including the unique parameter is an example of a second specific command. Further, the capability information returned from the MFP 1 in response to the capability request command including the specified parameter is an example of first capability information, and the capability information returned from the MFP 1 in response to the capability request command including the unique parameter is an example of second capability information.

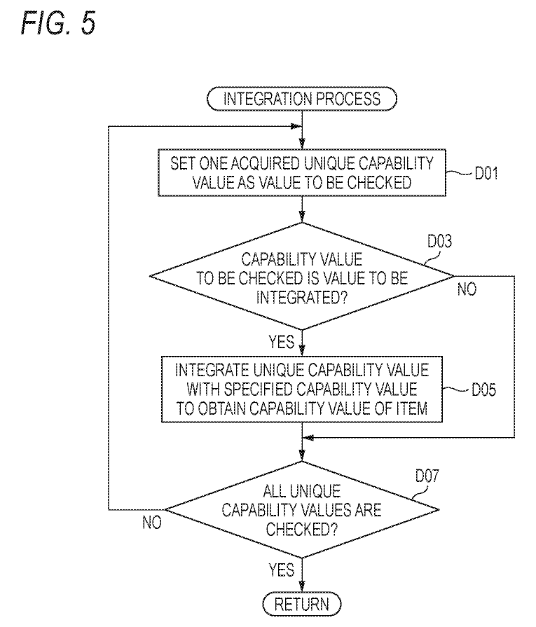

The auxiliary program 142 executes an integration process for integrating the specified capability value and the unique capability value based on the acquired capability information and determining a group of options that can be accepted as the print settings (A25). A procedure of the integration process will be described with reference to a flowchart in FIG. 5.

In the integration process, the CPU 111 sets one of the unique capability values included in the acquired capability information as a capability value to be checked (D01). Then, the CPU 111 determines whether the capability value to be checked is the capability value of an item to be integrated (D03). For example, the unique capability value of the color mode described above is a capability value related to the same item as the specified capability value of the color mode, and is a capability value to be integrated. The capability value indicating the print quality is also a capability value to be integrated. On the other hand, a capability value indicating the settable range for density and contrast and a capability value indicating whether the toner save mode is enabled are not capability values to be integrated because they are not items corresponding to the specified capability value.

If it is determined that the capability value is to be integrated (D03: YES), the CPU 111 integrates the unique capability value to be checked with the specified capability value of the same item to form a capability value of one item (D05). For example, the auxiliary program 142 integrates the unique capability value of the color mode and the specified capability value of the color mode to obtain the capability value of the color mode.

After D05 or if it is determined that the capability value is not to be integrated (D03: NO), the CPU 111 determines whether all the unique capability values have been checked (D07). If it is determined that there is an unchecked unique capability value (D07: NO), the CPU 111 proceeds to D01 to check the next unique capability value. If it is determined that all of the unique capability values have been checked (D07: YES), the CPU 111 ends the integration process.

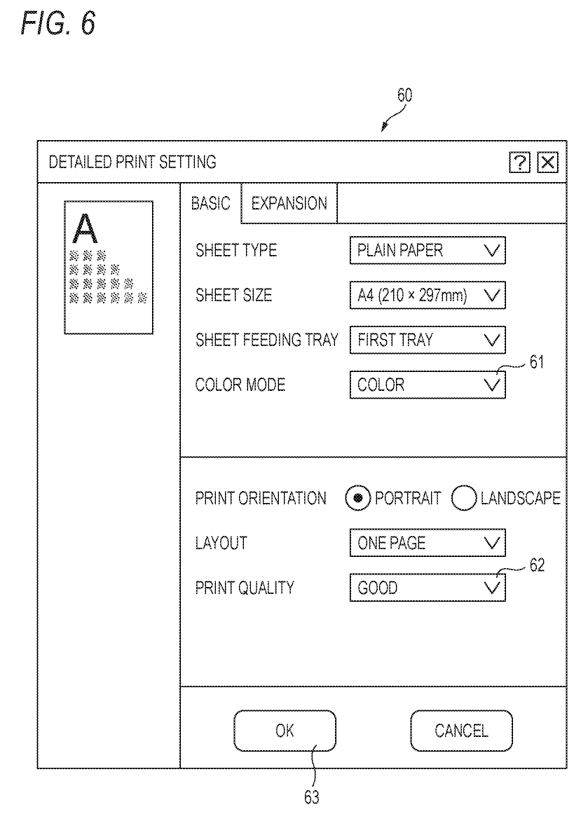

The description returns to the printing procedure shown in the sequence diagram of FIGS. 2A and 2B. After completing the integration process in A25, the auxiliary program 142 displays a print setting screen for receiving print settings on the user IF 113 based on the integrated capability values (A26). A26 is an example of a display process. For example, as illustrated in FIG. 6, the auxiliary program 142 displays a print setting screen 60 configured to receive selection of print setting values for various print setting items to accept an operation of the user. The print setting screen 60 is an example of the selection screen. When the capability information including a unique capability value is acquired, the auxiliary program 142 displays the print setting screen 60 including options indicating the print setting values corresponding to the unique capability value.

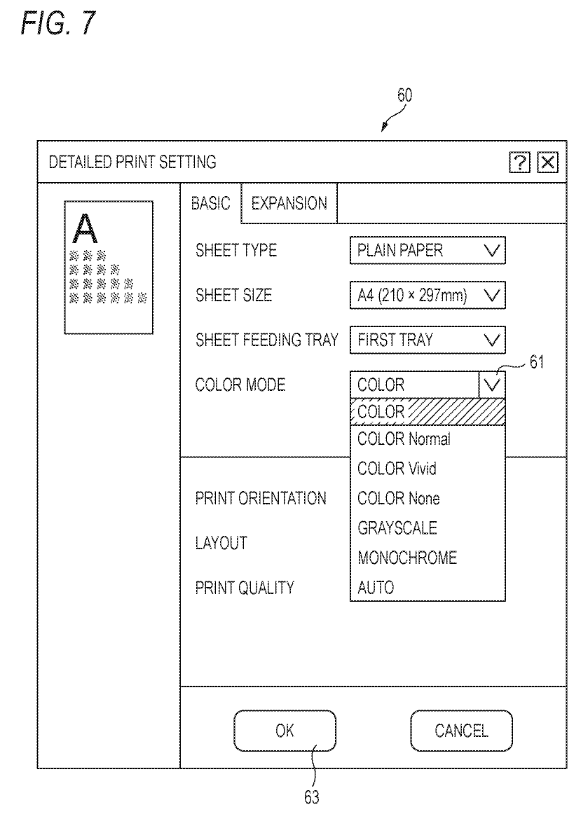

The user can select various print setting values by operating the displayed print setting screen 60 (A27). For example, when an operation on a setting item 61 of the color mode is received, the auxiliary program 142 displays a list of options for the color mode as illustrated in FIG. 7, and can receive the selection of the user.

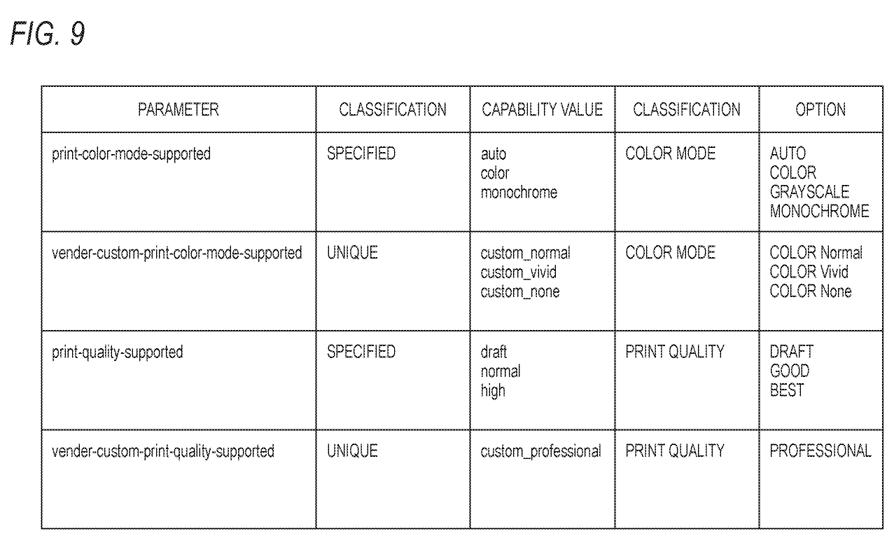

Depending on the capability value of the MFP 1, for example, as shown in FIG. 9, options that can be selected as print settings are provided. As described above, since the capability values of the color mode are integrated, the auxiliary program 142 displays color Normal, color Vivid, and color None, which correspond to the unique capability values in a selectable manner in addition to the options of auto, color, grayscale, and monochrome, which correspond to the specified capability values. The setting item 61 of the color mode is an example of the specific print setting item. The print setting value corresponding to each option of auto, color, grayscale, and monochrome, which corresponds to the specified capability value, is an example of a first setting value, and the print setting value corresponding to each option of color Normal, color Vivid, and color None, which corresponds to the unique capability value, is an example of a second setting value.

Further, for example, when an operation on a setting item 62 of the print quality is received, the auxiliary program 142 displays an option of professional which corresponds to the unique capability value of "custom_professional" in addition to good, draft, and best, which correspond to the specified capability values of "normal", "draft", and "high", respectively. Note that "good" is a setting value that indicates normal quality, "draft" is a setting value that indicates low quality, and "best" is a setting value that indicates high quality. "Professional" is a setting value that indicates higher quality than "Best". The setting item 62 of the print quality is an example of the specific print setting item. A print setting value corresponding to each option of good, draft, and best, which correspond to the specified capability values, is an example of a first setting value, and a print setting value corresponding to the option of professional, which corresponds to the unique capability value, is an example of a second setting value.

The auxiliary program 142 transmits a capability request command including the specified parameter and the unique parameter to the MFP 1, and acquires the specified capability value and the unique capability value of the MFP 1, so that the print setting value corresponding to the specified capability value and the print setting value corresponding to the unique capability value can be displayed in a selectable manner. Accordingly, the user can select a setting value based on either the specified capability value or the unique capability value.

After determination on all print settings, the user operates an OK button 63 on the print setting screen 60 to confirm the print setting values. The auxiliary program 142 stores the print setting value selected by the user in the memory 112 (A28). Further, the auxiliary program 142 passes information indicating that the print setting is completed to the general-purpose printing program 141 (A29). This enables the general-purpose printing program 141 to receive an instruction from the user, such as an instruction to execute printing. The auxiliary program 142 may pass, for example, information of the setting value corresponding to the specified capability value, among the information indicating the determined print setting values, to the general-purpose printing program 141.

When the general-purpose printing program 141 receives a print execution instruction from the user (A31), the general-purpose printing program 141 generates intermediate data based on the image data to be printed (A32). The general-purpose printing program 141 can generate the intermediate data based on image data to be printed acquired from an application program that creates or edits a document or an image, for example, and pass the generated intermediate data to the auxiliary program 142 (A33).

For example, the auxiliary program 142 acquires the intermediate data from the general-purpose printing program 141 and edits the intermediate data as necessary based on the print setting values stored in A28 (A34). Then, the auxiliary program 142 passes the edited intermediate data to the general-purpose printing program 141, thereby instructing the general-purpose printing program 141 to generate print data and transmit the print data to the MFP 1 (A35).

The general-purpose printing program 141 and the auxiliary program 142 may cooperate with each other to generate the print data in a manner different from the manner in which the auxiliary program 142 edits the intermediate data generated by the general-purpose printing program 141. For example, the auxiliary program 142 may generate the intermediate data and the print data. Further, if image data to be printed acquired from various application programs is data suitable for generating the print data, the general-purpose printing program 141 may generate the print data directly from the image data without generating the intermediate data.

The auxiliary program 142 may transmit a command to the MFP 1 before transmitting the print job based on the print setting values stored in A28. For example, when professional is selected as the print quality, the auxiliary program 142 may transmit a command to the MFP 1 instructing printing at professional quality. The auxiliary program 142 may perform transmission to the MFP 1 by itself, or may pass a command to the general-purpose printing program 141 to instruct transmission to the MFP 1.

The general-purpose printing program 141 generates a print job based on the intermediate data edited by the auxiliary program 142, and transmits the generated print job to the MFP 1 (A37). That is, the print job generated by the general-purpose printing program 141 designates the print setting values that the auxiliary program 142 receives from the user in A27 and stores in the memory in A28. If the print setting value corresponding to the unique capability value is designated by the user, the auxiliary program 142 can cause the MFP 1 to perform printing according to the unique capability value. Therefore, even if the PC 100 does not use a printer driver, it is possible to use the unique capability of the MFP 1. The processes of A34 and A35 by the auxiliary program 142 are processes for transmitting to the MFP 1 a print job in which the print setting value selected by the user is designated, and are an example of the job transmission process.

The MFP 1 executes printing based on the received print job (A38). If the MFP 1 receives a command associated with the print job, the MFP 1 executes an operation based on the received command during printing of the print job. As a result, a printed matter is output that is printed based on the print setting value selected by the user.

As described above in detail, in a case where a capability request command received from the IPP client includes a unique parameter, the MFP 1 according to the first embodiment responds with the capability information including the unique capability value of the MFP 1. Further, the auxiliary program 142 of the PC 100 can instruct the general-purpose printing program 141 of the PC 100 to transmit the capability request command including the unique parameter to the MFP 1. When the capability information including the unique capability value of the MFP 1 is acquired as a response to the capability request command including the unique parameter, the auxiliary program 142 can accept the print settings based on the unique capability value of the MFP 1. As a result, the unique capability originally held by the MFP 1 can be used even in a print job transmitted from the PC 100, which is an IPP client.

In the response capability determination process (see FIG. 4), if the parameter included in the capability request command is a specified parameter, only the specified capability value is added to the capability information, and if it is a unique parameter, only the unique capability value is added to the capability information. Alternatively, if the MFP 1 receives the capability request command including the unique parameter, the MFP 1 may add the corresponding specified capability value and unique capability value to the capability information even if the specified parameter corresponding to the unique parameter is not included. Even in this way, the MFP 1 can respond with the unique capability value in response to the capability request command that includes the unique parameter.

When a capability request command including a specified parameter and a unique parameter for the same item is transmitted to the MFP 1 configured in this way, the auxiliary program 142 may acquire the same specified capability value for both parameters. When the capability information including the same capability value in a duplicate manner is acquired, the auxiliary program 142 may replace the corresponding specified capability value with all the capability values responded to the unique parameter in D05 of the integration process (see FIG. 5) to obtain an integrated capability value. Then, the auxiliary program 142 may display a print setting screen that does not include duplicate options based on the integrated capability values. In this way, the user can still select a setting value based on either the specified capability value or the unique capability value.

Hereinafter, a second embodiment embodying a printer will be described in detail with reference to the accompanying drawings. The MFP 1 according to the second embodiment has a configuration similar to that of the MFP 1 according to the first embodiment, but executes processes that are partially different from those of the MFP 1 according to the first embodiment. The same configurations and procedures as MFP 1 according to the first embodiment are denoted by the same reference numerals as those of the first embodiment, and descriptions thereof will be omitted.

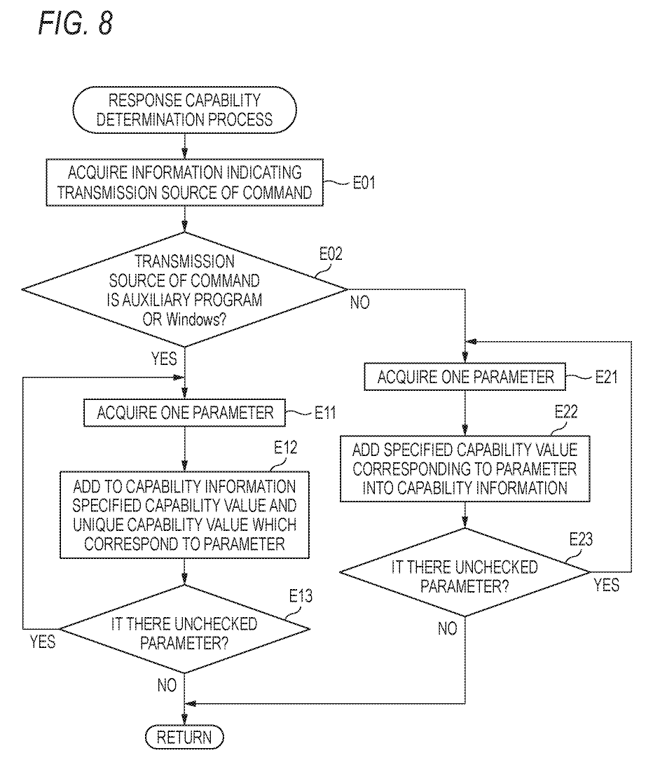

The MFP 1 according to the present embodiment can receive a capability request command from the PC 100 or the PC 200 as in the first embodiment. When the capability request command is received, the MFP 1 executes a response capability determination process that is different from the response capability determination process (see FIG. 4) performed by the MFP 1 in the first embodiment. A procedure of the response capability determination process according to the present embodiment will be described with reference to a flowchart in FIG. 8. The response capability determination process is executed by the CPU 11 of the MFP 1 of the present embodiment according to the capability response program 22 (see FIG. 1) of the MFP 1. At the start of the response capability determination process, the CPU 11 prepares capability information that does not include any information as response information.

In the response capability determination process of FIG. 8, the CPU 11 acquires identification information indicating a transmission source that has transmitted the received capability request command (E01). The MFP 1 can acquire information indicating a request source as, for example, User-Agent information associated with the capability request command in communication according to the IPP. The User-Agent information is an example of the identification information for identifying the IPP client.

In the present embodiment, when the auxiliary program 142 of the PC 100 instructs the general-purpose printing program 141 to transmit the capability request command (for example, A12 in FIG. 2A), the auxiliary program 142 may add User-Agent information indicating itself in association with the capability request command. In this case, the MFP 1 acquires information indicating the auxiliary program 142 in E01. When the auxiliary program 142 does not add the User-Agent information, the User-Agent information is information indicating the OS of the transmission source. For example, since the OS 121 of the PC 100 is Windows (registered trademark), information indicating "wPrintWindowDoc" is added as the User-Agent information to the capability request command transmitted from the PC 100.

On the other hand, since the OS 201 of PC 200 is not Windows, User-Agent information different from that of the capability request command transmitted from the PC 100 is added to the capability request command transmitted from the PC 200. For example, "CUPS2.3.4" and "macOS14.4" are added to the capability request command transmitted from the PC 200 as User-Agent information.

The CPU 11 determines whether the transmission source of the capability request command is the auxiliary program 142 or Windows based on the User-Agent information added to the capability request command (E02). If it is determined that the transmission source is the auxiliary program 142 or Windows (E02: YES), the CPU 11 acquires one parameter included in the received capability request command (E11). Then, the CPU 11 adds to the capability information the specified capability value and the unique capability value which correspond to the acquired parameter (E12).

For example, the User-Agent information indicating the auxiliary program 142 or Windows is added to the capability request command transmitted from the PC 100. That is, when the capability request command is received from the PC 100, the CPU 11 determines YES in E02. Then, even if the parameter included in the capability request command is a specified parameter, the CPU 11 responds with the specified capability value and the unique capability value which correspond to that parameter. For example, in a case where the capability request command includes a specified parameter that requests the capability of the color mode, the CPU 11 adds all of the specified capability values of auto, color, and monochrome, as well as the unique capability values of custom normal, custom vivid, and custom none to the capability information.

Then, the CPU 11 further determines whether there is an unchecked parameter (E13). If there is an unchecked parameter (E13: YES), the CPU 11 proceeds to E11 to acquire the next parameter.

In the present embodiment, the MFP 1 may also receive a capability request command that does not include a parameter. If the capability request command does not include a parameter, or if it includes "all", the CPU 11 responds to the transmission source of the command with capability information including all specified capability values and all unique capability values. The CPU 11 may respond by including, for example, a unique capability value that does not have a corresponding specified parameter in the capability information. If the capability request command includes a parameter designating a specific group, the CPU 11 responds to the transmission source of the command with capability information including all of the specified capability values and all of the unique capability values corresponding to the group designated by the parameter.

On the other hand, if it is determined that the User-Agent information in the capability request command is neither the auxiliary program 142 nor Windows (E02: NO), the CPU 11 acquires one parameter included in the received capability request command (E21). Then, the CPU 11 adds to the capability information only the specified capability value corresponding to the acquired parameter (E22).

For example, the User-Agent information indicating the auxiliary program 142 or Windows is not added to the capability request command transmitted from the PC 200. That is, when the capability request command is received from the PC 200, the CPU 11 determines NO in E02 and responds with only the specified capability value. For example, when the capability request command received from the PC 200 includes a specified parameter requesting the capability of the color mode, the CPU 11 responds with capability information including only auto, color, and monochrome of the specified capability value. In addition, for example, in a case where a parameter is not included in the capability request command received from the PC 200, or in a case where "all" is included, the CPU 11 responds with capability information including all of the specified capability values.

Then, the CPU 11 further determines whether there is an unchecked parameter (E23). If there is an unchecked parameter (E23: YES), the CPU 11 proceeds to E21 to acquire the next parameter. If it is determined that all parameters have been checked (E13: NO or E23: NO), the CPU 11 ends the response capability determination process and returns to the printing procedure shown in FIGS. 2A and 2B.

As described above, the MFP 1 according to the present embodiment responds with a unique capability value indicating the expanded function only to an IPP client that uses the IPP Class Driver that does not require authentication again. Therefore, the MFP 1 of the present embodiment does not need be authenticated again even after an update.

By acquiring the capability information including the unique capability value, the auxiliary program 142 according to the present embodiment determines a group of options corresponding to the unique capability value as a group of options that can be received as the print settings, similarly to the auxiliary program 142 according to the first embodiment. Then, the auxiliary program 142 displays the print setting screen 60 (see FIG. 6) that allows the user to select the print setting value from the determined group of options, and can receive the print settings from the user. Thereafter, the auxiliary program 142 can transmit a print job designating the print setting value selected by the user to the MFP 1 as in the first embodiment.

As described above in detail, when the transmission source of the capability request command is the auxiliary program 142 or Windows, the MFP 1 of the second embodiment responds with the capability information including the unique capability value. As a result, according to the MFP 1 of the second embodiment, similarly to the MFP 1 of the first embodiment, the unique capability that originally held by the MFP 1 can also be used in the print job transmitted from the PC 100, which is an IPP client.

Further, in the present embodiment, it is not necessary to prepare a unique parameter. Therefore, the MFP 1 does not need to consider the correspondence between the unique parameter and the specified parameter. Further, the auxiliary program 142 does not need to include a unique parameter, which simplifies the process. On the other hand, in the first embodiment, the relationship between the parameter included in the capability request command and the response capability value is simple. Therefore, the process of MFP 1 is simplified. In addition, the auxiliary program 142 can selectively include the unique parameter of only an item for which the unique capability value is necessary, there is a possibility that the communication load may be reduced.

Each of the embodiments disclosed in the present specification are merely an example, and does not limit the present invention. Therefore, various improvements and modifications can be naturally made to the technique disclosed in the present specification without departing from the gist of the present invention. For example, the printer is not limited to the MFP 1 and may be a single-function printer, a copier, or a FAX machine as long as it has a printing function and a communication function conforming to the IPP. Further, the IPP client is not limited to a PC, but may also be, for example, a smartphone or a tablet computer.

Further, for example, the print setting screens shown in FIGS. 6 and 7 are merely examples, and the configuration is not limited to those shown in these figures. Further, for example, the auxiliary program 142 may provide the information on the print setting screen as a part of the screen displayed by the general-purpose printing program 141, instead of displaying the print setting screen that is unique to the auxiliary program 142. Further, for example, the auxiliary program 142 may pass information indicating the options to the general-purpose printing program 141 to cause the general-purpose printing program 141 to display the print setting screen. In this case, the general-purpose printing program 141 may perform the process when an option corresponding to the specified capability value is selected, and the auxiliary program 142 may perform the process when an option corresponding to a unique capability value is selected.

Further, for example, the auxiliary program 142 may directly transmit the capability request command or a print job to the MFP 1 instead of instructing the general-purpose printing program 141 to transmit the capability request command or a print job to the MFP 1.

In the embodiment, although only the printing-related operations have been described in detail as the operations of the auxiliary program 142, the auxiliary program 142 may also have other roles. The program that executes the process of the present embodiment is not limited to the auxiliary program 142, but may be any program that receives an instruction from the OS 121 or the general-purpose printing program 141 when printing is performed using the general-purpose printing program 141. For example, a print workflow application (Print workflow) whose specifications have been published by Microsoft (registered trademark) may be used.

Further, an execution timing of the auxiliary program 142 is not limited to the example of the embodiments. For example, it may be executed in response to a direct execution instruction from the OS 121, or may be a resident auxiliary program 142. If it is resident, the auxiliary program 142 may receive an execution command and perform the above-described operations.

In any flowchart disclosed in the embodiment, an execution order of a plurality of processes in any of a plurality of steps can be freely changed or can be executed in parallel within a range in which no contradiction occurs in a processing content.

The processes disclosed in the embodiments may be executed by hardware such as a single CPU, a plurality of CPUs, and an ASIC, or a combination thereof. In addition, the processes disclosed in each embodiment can be implemented in various modes such as a recording medium in which a program for executing the processes is recorded, or a method.

What is claimed is:

1. A printer comprising:
a print engine; and
a communication interface,
wherein the printer is configured to:
receive a print job from an IPP client via the communication interface, according to internet printing protocol (IPP); and
cause the print engine to perform printing based on the received print job,
wherein the printer is configured to respond with capability information in response to receiving a specific command from the IPP client via the communication interface, the specific command being specified by IPP and requesting the capability information, the capability information indicating capabilities of the printer,
wherein the specific command includes a parameter for designating a requested capability, the parameter for designating a requested capability including a plurality of types, the plurality of types including a specified parameter that is the parameter specified in the IPP and a unique parameter that is the parameter not specified in the IPP, and
wherein the printer is further configured to:
in a case where the unique parameter is not included in the received specific command, respond with the capability information that includes, among the capabilities of the printer, a capability specified in the IPP and that does not include a capability not specified in the IPP; and
in a case where the unique parameter is included in the received specific command, respond with the capability information that includes, among the capabilities of the printer, a unique capability of the printer that is designated by the unique parameter and is not specified in the IPP.

2. The printer according to claim 1,
wherein the printer is configured to, in the case where the unique parameter is included in the received specific command, respond with the capability information that includes, among the capabilities of the printer, the unique capability designated by the unique parameter in a format specified by IPP.

3. The printer according to claim 1,
wherein the case where the unique parameter is not included in the specific command is a case where the parameter for designating a requested capability is not included in the specific command.

4. The printer according to claim 1,
wherein the case where the unique parameter is not included in the specific command is a case where the unique parameter is not included and the parameter that designates all specified capabilities of the printer is included in the specific command.

5. The printer according to claim 1,
wherein the case where the unique parameter is not included in the specific command is a case where the unique parameter is not included and the parameter that designates a group including a plurality of capabilities of the printer is included in the specific command.

6. The printer according to claim 1,
wherein the unique capability designated by the unique parameter is a capability corresponding to a print setting value to be set as a print setting,
wherein the printer is configured to, in the case where the unique parameter is included in the received specific command, respond with the capability information that includes, among the capabilities of the printer, the print setting value corresponding to the unique capability designated by the unique parameter, and
wherein after responding with the capability information that includes the print setting value corresponding to the unique capability designated by the unique parameter, the printer is configured to, in a case where the print job designating the print setting value included in the response capability information is received from the IPP client, cause the print engine to perform printing based on the received print job, according to the print setting value included in the response capability information.

7. The printer according to claim 6,
wherein a first setting value and second setting value are to be set for a specific print setting item specified in the IPP, the first setting value being a print setting value corresponding to a capability specified in the IPP, the second setting value being a print setting value corresponding to the unique capability,
wherein the printer is configured to, in a case where the unique parameter designating the specific print setting item is included in the received specific command, respond with the capability information that includes the second setting value, and
wherein after responding with the capability information that includes the second setting value, the printer is configured to, in a case where the print job designating the second setting value included in the response capability information for the specific print setting item is received from the IPP client, cause the print engine to perform printing based on the received print job, according to the second setting value.

8. The printer according to claim 7,
wherein the specific print setting item specified in the IPP is a color mode,
wherein the first setting value corresponding to the capability specified in the IPP includes respective print setting values indicating auto, color, and monochrome, and
wherein the second setting value corresponding to the unique capability includes a print setting value other than the print setting value corresponding to the capability specified in the IPP.

9. The printer according to claim 7,
wherein the specific print setting item specified in the IPP is print quality,
wherein the first setting value corresponding to the capability specified in the IPP includes respective print setting values indicating low quality, normal quality, and high quality, and
wherein the second setting value corresponding to the unique capability includes a print setting value other than the print setting value corresponding to the capability specified in the IPP.

10. A printer comprising:
a print engine; and
a communication interface,
wherein the printer is configured to:
receive a print job from an IPP client via the communication interface according to internet printing protocol (IPP); and
cause the print engine to perform printing based on the received print job,
wherein the printer is configured to respond with the capability information in response to receiving a specific command from the IPP client via the communication interface, the specific command being specified by IPP and requesting capability information indicating capabilities of the printer,
wherein the specific command includes a parameter for designating a requested capability, the parameter for designating a requested capability including a plurality of types, the plurality of types including a specified parameter that is the parameter specified in the IPP and a unique parameter that is the parameter not specified in the IPP,
wherein a first setting value and a second setting value are to be set for a specific print setting item specified in the IPP, the first setting vale being a print setting value corresponding to a capability specified in the IPP, the second setting value being a print setting value corresponding to a unique capability of the printer, and
wherein after responding with the capability information that includes the second setting value corresponding to the unique capability of the printer in response to receiving the specific command including the unique parameter, the printer is configured to, in a case where the print job designating the second setting value included in the response capability information for the specific print setting item is received from the IPP client, cause the print engine to perform printing based on the received print job, according to the second setting value.

11. The printer according to claim 10,
wherein the specific print setting item specified in the IPP is a color mode,
wherein the first setting value specified in the IPP includes respective print setting values indicating auto, color, and monochrome, and
wherein the second setting value not specified in the IPP includes a print setting value other than a print setting value specified in the IPP.

12. The printer according to claim 10,
wherein the specific print setting item specified in the IPP is print quality,
wherein the first setting value specified in the IPP includes respective print setting values indicating low quality, normal quality, and high quality, and
wherein the second setting value not specified in the IPP includes a print setting value other than a print setting value specified in the IPP.

13. A non-transitory computer readable storage medium storing a support program executable by a computer of an information processing device, the support program cooperating with an IPP client program included in an operating system of the information processing device,
the support program causing the computer to execute:
a capability acquisition process of transmitting, to a printer, a specific command specified by an IPP that requests capability information indicating capabilities of the printer, and of acquiring the capability information received from the printer as a response,
wherein the specific command includes a parameter for designating a requested capability, the parameter for designating a requested capability including a plurality of types, the plurality of types including a specified parameter that is the parameter specified in the IPP and a unique parameter that is the parameter not specified in the IPP, and
wherein after receiving the specific command, the printer is configured to:
in a case where the unique parameter is not included in the received specific command, respond with the capability information that includes, among the capabilities of the printer, a capability specified in the IPP and does not include a capability not specified in the IPP; and
in a case where the unique parameter is included in the received specific command, respond with the capability information that includes, among the capabilities of the printer, a unique capability of the printer that is designated by the unique parameter and is not specified in the IPP,
the support program causing the computer to further execute:
a display process of causing a user interface of the information processing device to display a selection screen for selecting a print setting value for a specific print setting item specified in the IPP, the selection screen including an option corresponding to a print setting value based on a capability included in the capability information acquired from the printer, and in a case where the unique capability is included in the capability information acquired from the printer, the selection screen further including an option corresponding to a print setting value based on the unique capability included in the capability information; and
a job transmission process of transmitting, to the printer, a print job designating the print setting value corresponding to the option selected on the selection screen.

14. The non-transitory computer readable storage medium according to claim 13,
wherein in the capability acquisition process, the specific command including the specified parameter that designates the specific print setting item and the unique parameter that designates the specific print setting item is transmitted to printer, and the capability information including both a first setting value that is a print setting value corresponding to a capability specified in the IPP and a second setting value that is a print setting value corresponding to the unique capability is acquired from the printer as a print setting value for the specific print setting item, and
wherein in the display process, the user interface of the information processing device is caused to display the selection screen for the specific print setting item, the selection screen including the options corresponding to the first setting value and the second setting value that are included in the capability information acquired from the printer.

15. The non-transitory computer readable storage medium according to claim 13,
wherein in the capability acquisition process,
a first specific command that is the specific command including the specified parameter that designates the specific print setting item, and a second specific command that is the specific command including the unique parameter that designates the specific print setting item are transmitted to the printer;
first capability information that is the capability information responded in response to the first specific command is acquired from the printer, the first capability information including, as a print setting value for the specific print setting item, a first setting value, which is a print setting value corresponding to a capability specified in the IPP; and
second capability information that is the capability information responded in response to the second specific command is acquired from the printer, the second capability information including, as a print setting value for the specific print setting item, a second setting value, which is a print setting value corresponding to the unique capability, and
wherein in the display process, the user interface of the information processing device is caused to display the selection screen for the specific print setting item, the selection screen including the option corresponding to the first setting value included in the first capability information acquired from the printer and the option corresponding to the second setting value included in the second capability information acquired from the printer.

16. The non-transitory computer readable storage medium according to claim 13,
wherein in the capability acquisition process, the specific command including the unique parameter that designates the specific print setting item is transmitted to printer, and the capability information including both a first setting value that is a print setting value corresponding to a capability specified in the IPP and a second setting value that is a print setting value corresponding to the unique capability is acquired from the printer as a print setting value for the specific print setting item, and
wherein in the display process, the user interface of the information processing device is caused to display the selection screen for the specific print setting item, the selection screen including the options corresponding to the first setting value and the second setting value that are included in the capability information acquired from the printer.

17. A printer comprising:
a print engine; and
a communication interface,
wherein the printer is configured to:
receive a print job from an IPP client via the communication interface according to internet printing protocol (IPP); and
cause the print engine to perform printing based on the received print job,
wherein the printer is configured to respond with the capability information in response to receiving a specific command from the IPP client via the communication interface, the specified command being specified by IPP and requesting capability information indicating capabilities of the printer,
wherein the specific command is associated with identification information for identifying the IPP client that is a request source, and
wherein the printer is further configured to:
in a case where the received specific command is associated with the identification information indicating a first type IPP client, respond with the capability information that includes, among the capabilities of the printer, a unique capability of the printer that is not specified in the IPP; and
in a case where the received specific command is associated with the identification information indicating a second type IPP client, respond with the capability information that includes, among the capabilities of the printer, a capability specified in the IPP and does not include the unique capability not specified in the IPP.

18. The printer according to claim 17,
wherein the specific command includes a parameter for designating a requested capability, and
wherein the printer is configured to, in a case where the received specific command does not include the parameter for designating a requested capability:
in a case where the received specific command is associated with the identification information indicating the first type IPP client, respond with the capability information that includes, among the capabilities of the printer, the unique capability that is a capability not specified in the IPP; and
in a case where the received specific command is associated with the identification information indicating the second type IPP client, respond with the capability information that includes, among the capabilities of the printer, a capability specified in the IPP and does not include the unique capability not specified in the IPP.

19. The printer according to claim 17,
wherein the specific command includes a parameter for designating a requested capability, and
wherein the printer is configured to, in a case where the received specific command includes the parameter for designating all capabilities of the printer:
in a case where the received specific command is associated with the identification information indicating the first type IPP client, respond with the capability information that includes, among the capabilities of the printer, the unique capability that is a capability not specified in the IPP; and
in a case where the received specific command is associated with the identification information indicating the second type IPP client, respond with the capability information that includes, among the capabilities of the printer, a capability specified in the IPP and does not include the unique capability not specified in the IPP.

20. The printer according to claim 17,
wherein the specific command includes a parameter for designating a requested capability, and
wherein the printer is configured to, in a case where the received specific command includes the parameter for designating a group including a plurality of capabilities of the printer:
in a case where the received specific command is associated with the identification information indicating the first type IPP client, respond with the capability information that includes, among the capabilities of the printer, the unique capability that is a capability not specified in the IPP; and
in a case where the received specific command is associated with the identification information indicating the second type IPP client, respond with the capability information that includes, among the capabilities of the printer, a capability specified in the IPP and does not include the unique capability not specified in the IPP.

21. The printer according to claim 17,
wherein the printer is configured to, in a case where the received specific command is associated with the identification information indicating the first type IPP client implemented in a specific operating system, respond with the capability information including, among the capabilities of the printer, the unique capability not specified in the IPP.

22. The printer according to claim 21,
wherein the printer is configured to, in a case where the received specific command is associated with the identification information indicating the first type IPP client that has Windows (registered trademark) installed as the specific operating system, respond with the capability information including, among the capabilities of the printer, the unique capability not specified in the IPP.

23. The printer according to claim 17,
wherein the printer is configured to, in a case where the received specific command is associated with the identification information indicating the first type IPP client that transmits the specific command in cooperation with a print support program, respond with the capability information including, among the capabilities of the printer, the unique capability not specified in the IPP.
